(19) United States
(12) Patent Application Publication
(10) Pub. No.: US 2021/0163109 A1
(43) Pub. Date: Jun. 3, 2021

(54) VERTICAL AXIS FLUID ENERGY CONVERSION DEVICE

(71) Applicant: Chung-Chi Chou, Tainan City (TW)

(72) Inventor: Chung-Chi Chou, Tainan City (TW)

(21) Appl. No.: 16/953,080

(22) Filed: Nov. 19, 2020

(30) Foreign Application Priority Data
Dec. 3, 2019 (TW) 108144016

(51) Int. Cl. B63H 9/02; F03D 1/06

(52) U.S. Cl. CPC B63H 9/02; F03D 3/007; F03D 1/0616

(57) ABSTRACT

A vertical axis fluid energy conversion device is provided. The vertical axis fluid energy conversion device includes at least one lift blade and at least one Magnus rotor. A power source drives the Magnus rotor to rotate and the Magnus lift force is produced. The Magnus rotor is connected with a main shaft through a connection component. Consequently, the main shaft is rotated and the lift blade is also revolved. The flow field of the vertical axis fluid energy conversion device is less influenced by the Magnus rotor. The performance of the lift blade is better. The whole efficiency is enhanced. The vertical axis fluid energy conversion device is self-starting through the Magnus rotor. The power source only drives the Magnus rotor to rotate, but not drive the whole device. Therefore, the vertical axis fluid energy conversion device has advantages of low cost and low energy consumption.

### CROSS-REFERENCE TO RELATED APPLICATION

This application claims priority to Taiwan Patent Application No. 108144016 filed on Dec. 3, 2019. The entire contents of the above-mentioned patent application are incorporated herein by reference for all purposes.

### FIELD OF THE INVENTION

The present disclosure relates to a vertical axis fluid energy conversion device, and more particularly to a vertical axis fluid energy conversion device which includes Magnus rotors. The Magnus rotors drive a main shaft to rotate according to the Magnus effect, and the main shaft drives lift blades to rotate. Consequently, the kinetic energy of the fluid is converted to the mechanical energy.

### BACKGROUND OF THE INVENTION

For the sustainable development of the global environment, the general trend is developing the eco-friendly green energy. All walks of life invest quite a few fund and human resources in green energy. The power generation device powered by fluid, such as wind or ocean current, has advantage of inexhaustible and powering without carbon dioxide. Consequently, energy conversion device that utilize the kinetic energy of fluids have always been the goal of development from all walks of life.

For instance, there are two kinds of the power generation device powered by wind according to the rotation direction of the main shaft. One is the horizontal axis wind turbine, and the other is the vertical axis wind turbine. The blades of the horizontal axis wind turbine have to face the wind direction. Consequently, the horizontal axis wind turbine is not suited for disposing in the environment with variety wind direction. Moreover, a power generator of the horizontal axis wind turbine is disposed within the cabin located at high place. Consequently, the horizontal axis wind turbine has disadvantage of difficulty maintaining, high center of gravity, weak structure and high cost. The vertical axis wind turbine does not have to face the wind direction. Consequently, the vertical axis wind turbine is suited for disposing in the environment with variety wind direction. Moreover, a power generator of the vertical axis wind turbine is disposed in the bottom of the vertical axis wind turbine. Consequently, the vertical axis wind turbine has advantage of low center of gravity, strong structure, easily maintaining and low cost.

There are two kinds of the vertical axis energy conversion device according to operation principle. One kind of the vertical axis energy conversion device uses drag blades, and the other kind of the vertical axis energy conversion device uses lift blades. The drag blades of the vertical axis energy conversion device can be self-starting in the flowing fluid, but the efficiency of the drag blades is worse. On the contrary, the efficiency of the lift blades of the vertical axis energy conversion device is higher, but the lift blades cannot be self-starting in the flowing fluid. Consequently, the vertical axis energy conversion device normally includes the drag blades and the lift blades working together. FIG. 1 is a schematic perspective view illustrating a first conventional vertical axis energy conversion device. As shown in FIG. 1, the first conventional vertical axis energy conversion device 1′ includes a plurality of Darrieus lift blades 2′ and a Savonius drag blade 3′. The plurality of Darrieus lift blades 2′ are located in the exterior of the first conventional vertical axis energy conversion device 1′. Moreover, the Savonius drag blade 3′ is disposed on a central rotation shaft 4′ and located in the interior of the first conventional vertical axis energy conversion device 1′. The Savonius drag blade 3′ includes two semicircle tubes. The cross section of the Savonius drag blade 3′ is shown in FIG. 2. The Savonius drag blade 3′ drives the plurality of Darrieus lift blades 2′ to revolve. FIG. 3 is a schematic perspective view illustrating a second conventional vertical axis energy conversion device. As shown in FIG. 3, the second conventional vertical axis energy conversion device 5′ includes a plurality of straight lift blades 6′ and a Savonius drag blade 3′. The plurality of straight lift blades 6′ are located in the exterior of the second conventional vertical axis energy conversion device 5′. The Savonius drag blade 3′ is disposed on a central rotation shaft 4′ of the second conventional vertical axis energy conversion device 5′ and located in the interior of the second conventional vertical axis energy conversion device 5′. The Savonius drag blade 3′ drives the plurality of straight lift blades 6′ to revolve. The above two conventional vertical axis energy conversion devices use the Savonius drag blade 3′ to overcome the problem that the lift blade is difficult to be self-starting.

FIG. 4 is a waveform diagram illustrating the tip speed ratio and the efficiency of the lift blade of the typical vertical axis fluid energy conversion device. As shown in FIG. 4, the horizontal axis represents the tip speed ratio of the lift blade. The definition of the tip speed ratio is the value between the tip speed of the blade and the flowing speed of the fluid, wherein the tip speed of the blade is the linear velocity of the blade but not the angular velocity of the blade. The vertical axis represents the efficiency of the lift blade. According to Betz law, the highest theory efficiency of converting the fluid energy is 0.59. As shown in FIG. 4, the highest realistic efficiency of the vertical axis fluid energy conversion device using the lift blade is about 0.45 when the tip speed ratio is 4.5. However, while the tip speed ratio is lower than 2, the efficiency of the lift blade is 0. That represents the output power of the vertical axis fluid energy conversion device is 0. Moreover, the power is equal to the torque multiplied by the rotation speed. Consequently, the vertical axis fluid energy conversion device does not output the torque, and the vertical axis fluid energy conversion device cannot be self-starting. The vertical axis fluid energy conversion device needs additional starting device. Due to the best theoretical efficiency of the above Savonius drag blade 3′ is occurred when the tip speed ratio of the Savonius drag blade 3′ is 1. For achieving the best efficiency of the lift blade and the best efficiency of the drag blade simultaneously, the revolution radius of the Savonius drag blade 3′ is usually equal to ¼ times of the revolution radius of the lift blade in realistic application, as shown in FIGS. 1 and 3. In the same rotation speed of the main shaft, the tip speed of the blade is proportional to the radius of the blade. Consequently, the speed of the lift blade is higher than four times speed of the drag blade. The best efficiency of the lift blade and the best efficiency of the drag blade are expected to achieve simultaneously.

However, while the revolution radius of the Savonius drag blade 3′ is shorter, such as ¼ times of the revolution radius of the lift blade, the torque generated by the Savonius drag blade 3′ is not enough. The vertical axis fluid energy conversion device still cannot be self-starting in the low flowing speed of the fluid. Consequently, the radius or the height of the drag blade is increased to enlarge the cross section and increase the torque. However, this causes the flow field inside the vertical axis fluid energy conversion device is disturbed and the performance of the lift blade is influenced. Consequently, the whole efficiency of the vertical axis fluid energy conversion device is decreased. Therefore, while the Savonius drag blade 3′ is served as a starting device, it is difficult to meet the self-starting and achieve high efficiency simultaneously. Moreover, while the flowing speed of the fluid is too high, the huge torque generated by the Savonius drag blade 3′ will drive the vertical axis fluid energy conversion device to overspeed, and danger is occurred easily.

Recently, the active pitch control can change the angle of the lift blade according to the flowing direction of the fluid and achieve self-starting. However, this will make the structure of the vertical axis fluid energy conversion device more complex, weak and expensive due to the increase of moving parts. Moreover, the way of disposing a starting motor in the central rotation shaft to increase the rotation speed is a solution for driving the lift blade to start revolving. However, the central rotation shaft is connected with the whole vertical axis fluid energy conversion device, so that the inertia is large. The motor has to employ a reducer to output enough torque, and the motor also has to employ an inverter and a clutch. Consequently, the cost is increased and the energy consumption is increased. So the vertical axis fluid energy conversion device has not been successfully applied for a long time.

Therefore, there is a need of providing a vertical axis fluid energy conversion device to solve the issues encountered by the prior arts.

### SUMMARY OF THE INVENTION

An object of the present disclosure provides a vertical axis fluid energy conversion device capable of being self-starting and having advantages of high efficiency, low cost and low energy consumption.

In accordance with an aspect of the present disclosure, a vertical axis fluid energy conversion device for converting a kinetic energy of a fluid to a mechanical energy is provided. The vertical axis fluid energy conversion device includes at least one lift blade, a main shaft, at least one Magnus rotor and a connection component. The main shaft includes a first axis. The main shaft is rotated around the first axis. Each of the at least one Magnus rotor includes a power source and a second axis. The power source drives the corresponding Magnus rotor to rotate around the corresponding second axis selectively. The connection component is connected with the main shaft and the corresponding Magnus rotor. Each of the at least one Magnus rotor produces a lift force according to Magnus effect when the Magnus rotor is rotated on its own axis (i.e. the second axis). The connection component is served as a moment arm, and the lift force acts on the moment arm to form a torque. The main shaft is driven to rotate around the first axis in response to the torque. Each of the at least one Magnus rotor is also revolved around the first axis. The connection component is also connected with the main shaft and the corresponding lift blade. While the Magnus rotor drives the main shaft to rotate, each of the at least one lift blade is also driven to revolve around the first axis. While a revolution speed of the lift blade is greater than a speed threshold value, the efficiency of the lift blade is increased. A torque produced by the lift blade is greater than a resistance of the fluid and a friction of the main shaft, such that the main shaft is continuously driven to rotate around the first axis. A revolution radius of the Magnus rotor revolved around the first axis is less than a revolution radius of the lift blade revolved around the first axis.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a first conventional vertical axis fluid energy conversion device;

FIG. 2 is a cross-sectional view illustrating Savonius drag blades of the first conventional vertical axis fluid energy conversion device of FIG. 1.

FIG. 3 is a schematic perspective view illustrating a second conventional vertical axis fluid energy conversion device;

FIG. 4 is a waveform diagram illustrating the tip speed ratio and efficiency of lift blades of the typical vertical axis fluid energy conversion device;

FIG. 5A is a schematic perspective view illustrating a vertical axis fluid energy conversion device according to a first embodiment of the present disclosure;

FIG. 5B is a top view illustrating the vertical axis fluid energy conversion device of FIG. 5A;

FIG. 6 is a top view illustrating the operation of a Magnus rotor of the vertical axis fluid energy conversion device of FIG. 5A;

FIG. 7 is a circuit block diagram illustrating the vertical axis fluid energy conversion device of FIG. 5A;

FIG. 8 is an X-Y coordinate system illustrating the main shaft and the plurality of Magnus rotors of the vertical axis fluid energy conversion device of FIG. 5A;

FIG. 9 is a waveform diagram illustrating the driving signal of the Manus rotor of the vertical axis fluid energy conversion device of FIG. 5A;

FIG. 10 is a waveform diagram illustrating the tip speed ratio and the efficiency of the lift blade of the vertical axis fluid energy conversion device of FIG. 5A;

FIG. 11 is a control block diagram illustrating the control unit of the vertical axis fluid energy conversion device of FIG. 5A;

FIG. 12A is a schematic perspective view illustrating a vertical axis fluid energy conversion device according to a second embodiment of the present disclosure;

FIG. 12B is a top view illustrating the vertical axis fluid energy conversion device of FIG. 12A;

FIG. 13A is a schematic perspective view illustrating a vertical axis fluid energy conversion device according to a third embodiment of the present disclosure;

FIG. 13B is a top view illustrating the vertical axis fluid energy conversion device of FIG. 13A;

FIG. 14 is a top view illustrating a vertical axis fluid energy conversion device according to a fourth embodiment of the present disclosure;

FIG. 15 is a schematic perspective view illustrating lift blades of a vertical axis fluid energy conversion device according to a fifth embodiment of the present disclosure;

FIG. 16A is a schematic perspective view illustrating a vertical axis fluid energy conversion device according to a sixth embodiment of the present disclosure;

FIG. 16B is a top view illustrating the vertical axis fluid energy conversion device of FIG. 16A;

FIG. 17A is a schematic perspective view illustrating a vertical axis fluid energy conversion device according to a seventh embodiment of the present disclosure;

FIG. 17B is a cross-sectional view illustrating portion of an exemplary vertical axis fluid energy conversion device of FIG. 17A; and

FIG. 17C is a cross-sectional view illustrating portion of another exemplary vertical axis fluid energy conversion device of FIG. 17A.

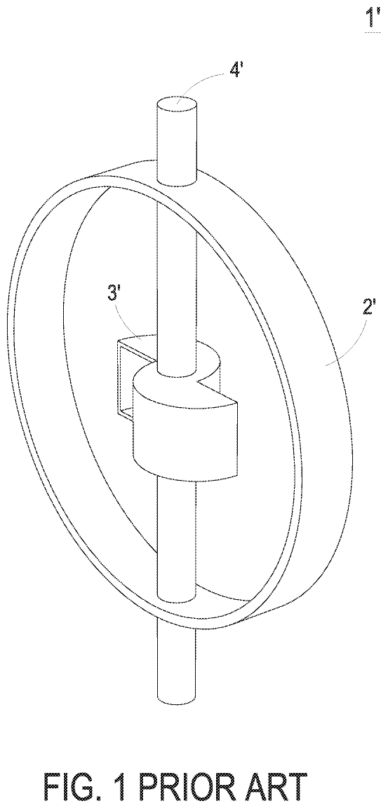

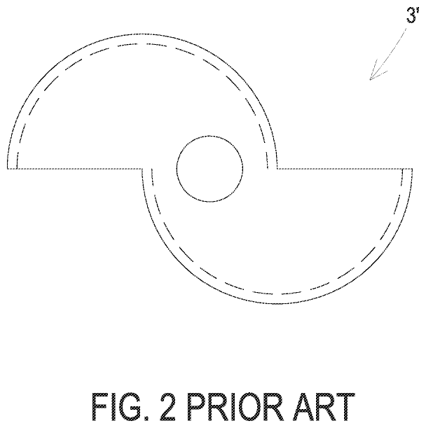

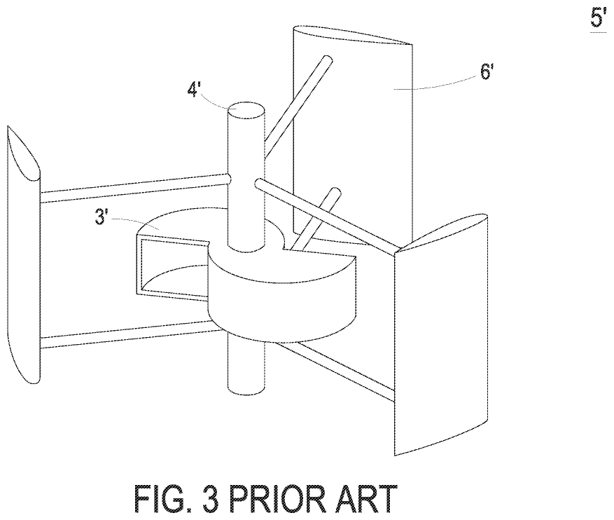

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

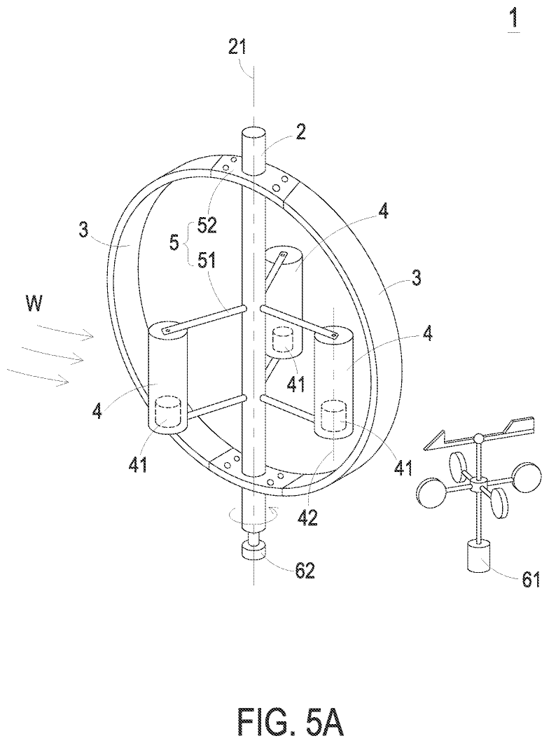

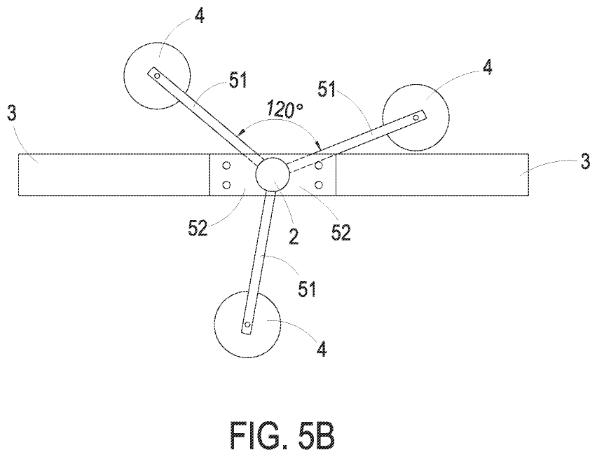

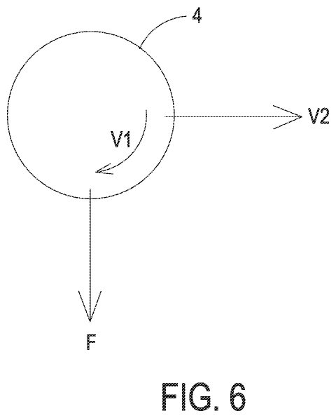

FIG. 5A is a schematic perspective view illustrating a vertical axis fluid energy conversion device according to a first embodiment of the present disclosure. FIG. 5B is a top view illustrating the vertical axis fluid energy conversion device of FIG. 5A. FIG. 6 is a top view illustrating the operation of a Magnus rotor of the vertical axis fluid energy conversion device of FIG. 5A. As shown in FIGS. 5A, 5B and 6, the vertical axis fluid energy conversion device 1 is disposed in the fluid W. For example, the fluid W is wind or water. The vertical axis fluid energy conversion device 1 converts the kinetic energy of the fluid W to the mechanical energy of a main shaft 2 of the vertical axis fluid energy conversion device 1 for driving the load. While the load is a generator, the vertical axis fluid energy conversion device 1 can generate electric power. The vertical axis fluid energy conversion device 1 includes a main shaft 2, at least one lift blade 3, at least one Magnus rotor 4 and a connection component 5.

The main shaft 2 includes a first axis 21. The first axis 21 is constituted of an axis line which passes through the center of a top end of the main shaft 2 and the center of a bottom end of the main shaft 2. The main shaft 2 is rotated around the first axis 21. In this embodiment, the number of the lift blades 3 is two. The lift blades 3 are curved, respectively, and the profiles of the lift blades 3 are similar to that of an egg beater. Preferably but not exclusively, the lift blades 3 are curved wing blades. As shown in FIG. 5B, the two lift blades 3 are separated from each other and disposed around the main shaft 2 evenly. The number of the Magnus rotors 4 is three. The three Magnus rotors 4 are separated from each other and disposed around the main shaft 2 evenly. Each Magnus rotor 4 includes a power source 41 and a second axis 42. The second axis 42 is constituted of an axis line which passes through the center of a top end of the Magnus rotor 4 and the center of a bottom end of the Magnus rotor 4. The power source 41 is for example but not limited to a motor or an engine. Each power source 41 selectively drives the corresponding Magnus rotor 4 to rotate around the second axis 42. While the Magnus rotor 4 is disposed in the fluid W which is flowing, the Magnus rotor 4 produces the lift force of the Magnus effect by the rotation of the Magnus rotor 4. As shown in FIG. 6, taking one of the Magnus rotors 4 for example, the Magnus rotor 4 is a cylinder structure. The Magnus rotor 4 is rotated on its own axis (i.e. the second axis 42). For example, the Magnus rotor 4 is rotated in clockwise, the angular velocity is represented as V1 and the velocity relative to the fluid W is represented as V2. The Magnus rotor 4 produces lift force F according to the Magnus effect. The magnitude of the lift force F is proportional to the angular velocity V1 of the Magnus rotor 4 and the velocity V2 relative to the fluid W. The direction of the lift force F is perpendicular to the direction of the velocity V2 of the Magnus rotor 4 relative to the fluid W. While the rotation direction of the Magnus rotor 4 is in counterclockwise, the direction of the lift force F is reversed.

In this embodiment, the connection component 5 includes a plurality of first connection parts 51 and a plurality of second connection parts 52. Each of the plurality of first connection parts 51 is connected to the main shaft 2 and the top of the corresponding Magnus rotor 4, or each of the plurality of first connection parts 51 is connected to the main shaft 2 and the bottom of the corresponding Magnus rotor 4. While each of the Magnus rotors 4 is rotated on its own axis, the lift force of the Magnus effect is produced and applied on the moment arm formed by the first connection part 51 to generate torque, so that the main shaft 2 is rotated around the first axis 21 in response to the torque. Each of the plurality of second connection parts 52 is fixed on the main shaft 2 for connecting the main shaft 2 and the corresponding lift blade 3. Consequently, while the Magnus rotor 4 drives the main shaft 2 to rotate, each lift blade 3 is also driven to revolve around the first axis 21 of the main shaft 2. While the revolution speed of the lift blade 3 is faster than a speed threshold value, for example, the tip speed ratio of the lift blade 3 is 2.5, the efficiency of the lift blade 3 is increased. The torque produced by the lift blade 3 is greater than the resistance of the fluid W and the friction of the main shaft 2. At this time, even though the power source 41 is turned off and the rotation of the Magnus rotors 4 is stopped, the torque produced by the lift blade 3 can still drive the main shaft 2 to accelerate. Taking wind power generation for example, at this time, the main shaft 2 can drive the generator to generate electric power.

From above, the vertical axis fluid energy conversion device 1 of the present disclosure includes at least one lift blade 3 and at least one Magnus rotor 4. The rotation of the Magnus rotor 4 on its own axis produces the Magnus lift force, and the Magnus rotor 4 is connected to the main shaft 2 through the connection component 5. Consequently, the vertical axis fluid energy conversion device 1 starts up the lift blade 3 to revolve by the Magnus lift force of the Magnus rotor 4. Moreover, the Magnus rotor 4 is driven to rotate on its own axis through the power source 41. By increasing the rotation speed of the Magnus rotor 4, the required Magnus lift force can be obtained. Consequently, the diameter of the Magnus rotor 4 can be designed to be shorter. Compared with the conventional Savonius drag blade, the cross-sectional area of the Magnus rotor 4 is reduced. Consequently, the flow field inside the vertical axis fluid energy conversion device 1 is less influenced. So the performance of the lift blade 3 of the present disclosure is better, that the whole efficiency of the vertical axis fluid energy conversion device 1 is enhanced.

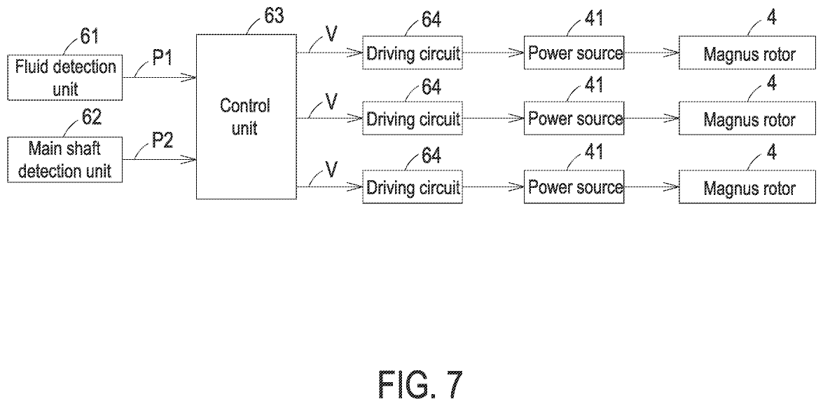

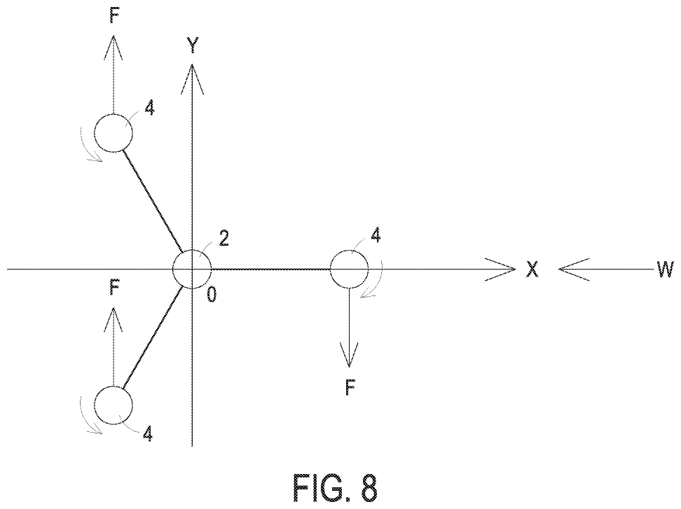

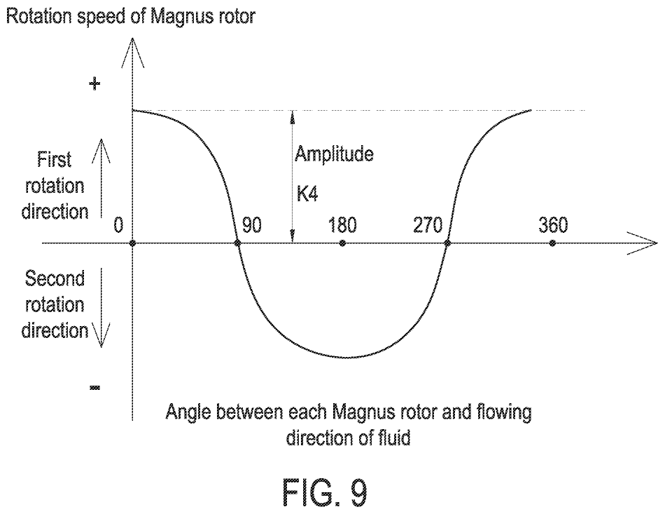

FIG. 7 is a circuit block diagram illustrating the vertical axis fluid energy conversion device of FIG. 5A. FIG. 8 is an X-Y coordinate system illustrating the main shaft and the plurality of Magnus rotors of the vertical axis fluid energy conversion device of FIG. 5A. FIG. 9 is a waveform diagram illustrating the driving signal of the Magnus rotor of the vertical axis fluid energy conversion device of FIG. 5A. As shown in FIGS. 5A, 5B, and 6 to 9, the vertical axis fluid energy conversion device 1 further includes a fluid detection unit 61, a main shaft detection unit 62, a control unit 63 and at least one driving circuit 64. The fluid detection unit 61 detects the flowing speed and the flowing direction of the fluid W and outputs a first detection signal P1. The main shaft detection unit 62 detects the rotation angle of the main shaft 2 rotated around the first axis 21 and outputs a second detection signal P2. The control unit 63 is connected with the fluid detection unit 61 and the main shaft detection unit 62 in order to receive the first detection signal P1 and the second detection signal P2. The control unit 63 calculates an angle difference according to the flowing direction of the fluid W and the rotation angle of the main shaft 21 rotated around the first axis 21 in order to calculate the angle between each Magnus rotor 4 and the flowing direction of the fluid W. Then a driving signal V is obtained, which is outputted to the corresponding power source 41 through the corresponding driving circuit 64 to drive the corresponding Magnus rotor 4 to rotate.

Please refer to FIG. 8 again. The main shaft 2 is perpendicular to an original point O of the X-Y coordinate system. The positive direction of the X axis is faced to the flowing direction of the fluid W. Consequently, the vertical axis fluid energy conversion device 1 has a first side facing to the flowing direction of the fluid W and a second side facing away from the flowing direction of the fluid W. The first side is located in the right side of the Y axis of FIG. 8. The second side is located in the left side of the Y axis of FIG. 8. The rotation direction of the Magnus rotor 4 located in the first side must be opposite to the rotation direction of the Magnus rotor 4 located in the second side. So that each Magnus rotor 4 applies torque in the same direction on the main shaft 2. As shown in FIG. 9, each Magnus rotor 4 has two rotation directions according to the angle between each Magnus rotor 4 and the flowing direction of the fluid W. The angle between 0 degree and 90 degrees and the angle between 270 degrees and 360 degrees are defined as a first rotation direction. The angle between 90 degrees and 270 degrees is defined as a second rotation direction. While the Magnus rotor 4 is revolved around the first axis 21, the rotation direction of the Magnus rotor 4 on its own axis is changed continuously. In an embodiment, in order to make the rotation speed of the Magnus rotor 4 smooth and avoid vibration, the rotation speed of each Magnus rotor 4 is planned as a sine wave, as shown in FIG. 9. In some embodiments, the rotation speed of each Magnus rotor 4 can also be triangular wave, trapezoid wave, square wave or any other waveform with changeable direction.

The control unit 63 controls the power source 41 of the Magnus rotor 4 located in the first side through the corresponding driving signal V. So that each Magnus rotor 4 located in the first side is rotated on its own axis in the first rotation direction. And the rotation speed of each Magnus rotor 4 is adjusted dynamically according to the angle difference between the revolving angle of the Magnus rotor 4 and the flowing direction of the fluid W. Moreover, the control unit 63 controls the power source 41 of the Magnus rotor 4 located in the second side through the corresponding driving signal V. So that each Magnus rotor 4 located in the second side is rotated on its own axis in the second rotation direction opposite to the first rotation direction. And the rotation speed of each Magnus rotor 4 is adjusted dynamically according to the angle difference between the revolving angle of the Magnus rotor 4 and the flowing direction of the fluid W. By means of controlling the rotation of each Magnus rotor 4, each Magnus rotor 4 obtains the Magnus lift force which is applied to the moment arm formed by the first connection part 51 to generate torque to drive the main shaft 2 to rotate in the first rotation direction.

In some embodiments, the control unit 63 obtains the flowing speed of the fluid W according to the first detection signal P1 and obtains the angular velocity of the main shaft 2 according to the second detection signal P2. The lift blade 3 is connected with the main shaft 2 through the second connection part 52, and the lift blade 3 is revolved around the first axis 21 of the main shaft 2, so the angular velocity of the lift blade 3 is the same as the angular velocity of the main shaft 2. Consequently, the linear velocity of the lift blade 3 can be obtained by multiplying the angular velocity of the main shaft 2 by the revolution radius of the lift blade 3. Then divide the linear velocity of the lift blade 3 by the flowing speed of the fluid W detected by the first detection signal P1 to obtain the tip speed ratio of the lift blade 3, shown as the following formula (1).

tip speed ratio=linear velocity of blade/flowing speed of fluid=(angular velocity of blade×revolution radius of blade)/flowing speed of fluid (1)

The formula (1) can be converted to formula of the angular velocity of the blade as follows.

angular velocity of blade=(tip speed ratio×flowing speed of fluid)/revolution radius of blade (2)

The above formula (1) and the formula (2) are applicable to both the lift blade 3 and the Magnus rotor 4.

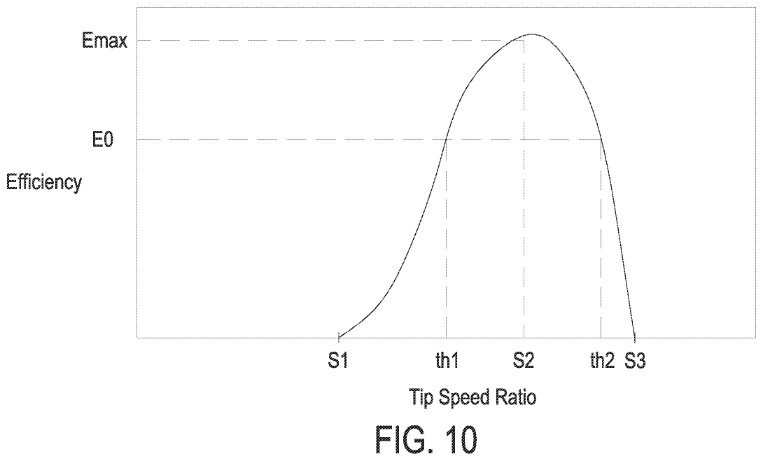

Since the efficiency of the vertical axis fluid energy conversion device 1 is closely related to the tip speed ratio of the lift blade 3. Taking a wind power generator for example, due to the variation of the wind speed, the tip speed ratio of the lift blade 3 is changed at any time even if the rotation speed of the main shaft 2 remains unchanged. Thus, making the efficiency of the vertical axis fluid energy conversion device 1 worse. Consequently, the tip speed ratio of the lift blade 3 should be controlled to maintain at a better efficiency. FIG. 10 is a waveform diagram illustrating the tip speed ratio and the efficiency of the lift blade of the vertical axis fluid energy conversion device of FIG. 5A. As shown in FIG. 10, the horizontal axis represents the ratio between the linear velocity of the lift blade 3 and the flowing speed of the fluid W (i.e. the tip speed ratio of the lift blade 3). The vertical axis represents the efficiency of the vertical axis fluid energy conversion device 1. As shown in FIG. 10, while the tip speed ratio of the lift blade 3 is less than or equal to a first tip speed ratio S1, the efficiency of the vertical axis fluid energy conversion device 1 is 0. While the tip speed ratio of the lift blade 3 is increased to a second tip speed ratio S2, the efficiency of the vertical axis fluid energy conversion device 1 is increased to a maximum value Emax. While the tip speed ratio of the lift blade 3 is increased to a third tip speed ratio S3, the efficiency of the vertical axis fluid energy conversion device 1 is decreased to 0. When the efficiency of the vertical axis fluid energy conversion device 1 is equal to the maximum value Emax, the corresponding value of the second tip speed ratio S2 is usually between 4 and 5, which is mainly related to solidity of the lift blade 3. The value of the second tip speed ratio S2 can be easily obtained by those skilled in the art with experiment, and is not redundantly described herein.

The vertical axis fluid energy conversion device 1 controls the revolution speed of the lift blade 3 by controlling the rotation speed and the rotation direction of the Magnus rotor 4, thereby controlling the tip speed ratio of the lift blade 3 to keep the efficiency of the vertical axis fluid energy conversion device 1 to be optimal. According to demand of user, a target tip speed ratio of the lift blade 3 is set between a first threshold value th1 and a second threshold value th2. The first threshold value th1 is less than the second tip speed ratio S2. The second tip speed ratio S2 is less than the second threshold value th2. Consequently, the efficiency of the vertical axis fluid energy conversion device 1 is maintained between a setting value E0 and the maximum value Emax. For example, while the tip speed ratio of the lift blade 3 is located between the first threshold value th1 and the second threshold value th2, the efficiency of the vertical axis fluid energy conversion device 1 is satisfied. Meanwhile, the power source 41 can be turned off to stop the rotation of the Magnus rotor 4 to save energy consumption. However, while the tip speed ratio of the lift blade 3 is less than the first threshold value th1 (i.e. the efficiency of the lift blade 3 is less than the setting value E0), the corresponding driving signal V is outputted to the power source 41 to drive the corresponding Magnus rotor 4 to rotate to generate the torque in the same revolution direction as the lift blade 3. Consequently, the revolution speed of the lift blade 3 is increased. The tip speed ratio of the lift blade 3 is also increased, and then back to between the first threshold value th1 and the second threshold value th2, so that the efficiency of the vertical axis fluid energy conversion device 1 is maintained between the setting value E0 and the maximum value Emax.

Moreover, while the tip speed ratio of the lift blade 3 is greater than the second threshold value th2 (i.e. the efficiency of the lift blade 3 is less than the setting value E0), usually it is not necessary to drive the Magnus rotor 4 to rotate to decrease the tip speed ratio. If the torque characteristic of the load (i.e. the generator) is properly matched, the torque of the load is greater than the torque generated from the main shaft 2 when the tip speed ratio is too high. Consequently, the rotation speed of the main shaft 2 is naturally decreased, and the tip speed ratio of the lift blade 3 returns between the first threshold value th1 and the second threshold value th2. However, for avoiding overloaded while the flowing speed of the fluid W is too high and the rotation speed of the main shaft 2 is greater than a rated rotation speed of the load, the corresponding driving signal V is outputted to the power source 41 to drive the corresponding Magnus rotor 4 to rotate to generate the torque in the opposite revolution direction to the lift blade 3. So the rotation speed of the main shaft 2 is decreased and danger is avoided from exceeding the rated rotation speed of the load. Hence, the vertical axis fluid energy conversion device 1 can operate safely under higher flowing speed of the fluid W without immediately activating a brake to stop the operation. Therefore, the utilization rate of the vertical axis fluid energy conversion device 1 is increased.

In some embodiments, while the actual rotation speed of the main shaft 2 rotated around the first axis 21 is less than a target rotation speed, the control unit 63 controls the amplitude of the rotation speed of each Magnus rotor 4 to increase. While the actual rotation speed of the main shaft 2 rotated around the first axis 21 is equal to the target rotation speed, the control unit 63 controls the amplitude of the rotation speed of each Magnus rotor 4 to maintain. While the actual rotation speed of the main shaft 2 rotated around the first axis 21 is greater than the target rotation speed, the control unit 63 controls the amplitude of the rotation speed of each Magnus rotor 4 to decrease. In order that the actual rotation speed of the main shaft 2 is controlled to track the target rotation speed. The implement method is as follows.

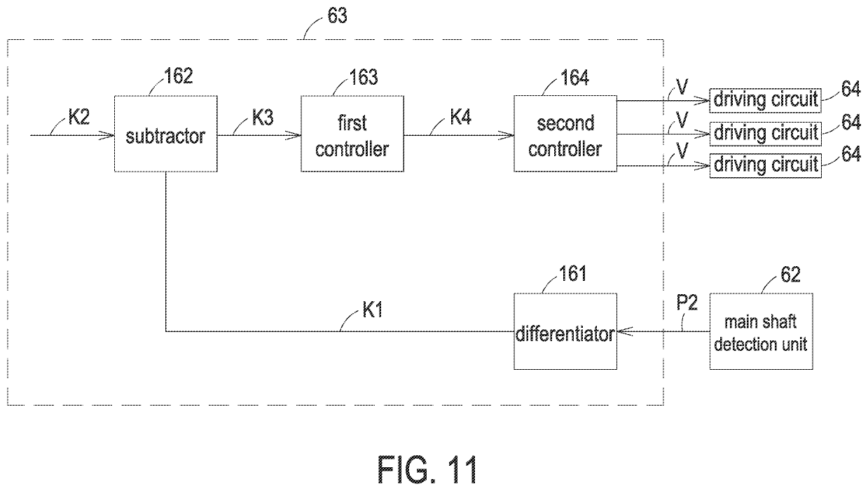

FIG. 11 is a control block diagram illustrating the control unit of the vertical axis fluid energy conversion device of FIG. 5A. As shown in FIG. 11, the control unit 63 includes a differentiator 161, a subtractor 162, a first controller 163 and a second controller 164. The differentiator 161 is connected with the main shaft detection unit 62 to receive the second detection signal P2 and differentiates the second detection signal P2 which is the rotation angle of the main shaft 2 rotating around the first axis 21, thus obtains the actual rotation speed of the main shaft 2 and outputs an actual rotation speed signal K1 of the main shaft 2. The subtractor 162 is connected with the differentiator 161 to receive the actual rotation speed signal K1. The subtractor 162 subtracts the actual rotation speed signal K1 from a target rotation speed command K2 to obtain a rotation speed error signal K3, and the target rotation speed command K2 can be calculated by taking the second tip speed ratio S2 corresponding to that the efficiency of the lift blade 3 is the maximum value into formula (2). The target rotation speed command K2 must be less than the maximum rotation speed that the main shaft 2 and the load can bear.

The first controller 163 is connected with the subtractor 162 to receive the rotation speed error signal K3 of the main shaft 2. The first controller 163 outputs a waveform amplitude signal K4 according to the rotation speed error signal K3 by for example but not limited to the PID algorithm. The second controller 164 is connected with the first controller 163 to receive the waveform amplitude signal K4. In this embodiment, the driving signal V of the Magnus rotor 4 is outputted by the second controller 164, wherein the driving signal V is the waveform amplitude signal K4 multiplied by a cosine function. As the waveform diagram of FIG. 9 is represented as a function which is K4·COS(θ+Δ). The symbol θ of the function represents the angle between the Magnus rotor 4 and the flowing direction of the fluid W. The symbol Δ of the function represents an angle compensation value. Moreover, the Magnus rotor 4 is affected by the lift force and the drag force. In the practice, the angle compensation value Δ is utilized to adjust the phase of the waveform diagram of FIG. 9 so as to modify the driving signal V of the power source 41 in order that the performance of the vertical axis fluid energy conversion device 1 is enhanced. In some embodiments, the angle compensation value Δ can be obtained through experiments as a function of the actual rotation speed signal K1. In some other embodiments, the angle compensation value Δ is 0 while the angle compensation is not used.

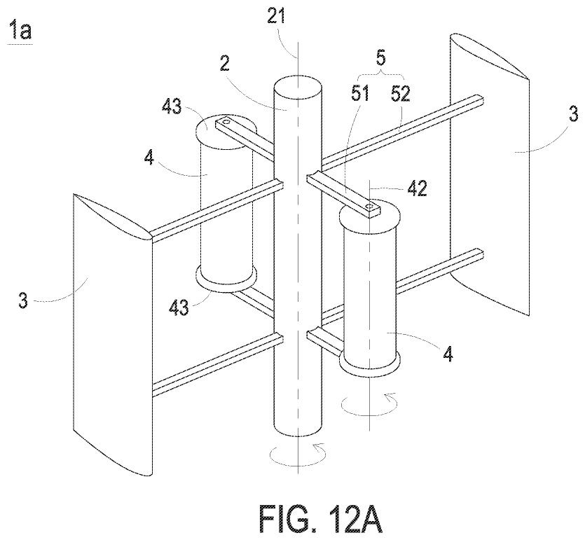

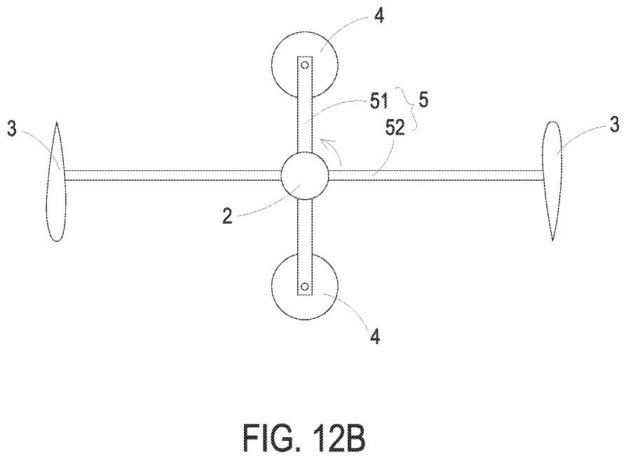

FIG. 12A is a schematic perspective view illustrating a vertical axis fluid energy conversion device according to a second embodiment of the present disclosure. FIG. 12B is a top view illustrating the vertical axis fluid energy conversion device of FIG. 12A. As shown in FIGS. 12A and 12B, the vertical axis fluid energy conversion device 1a of this embodiment includes a main shaft 2, at least one lift blade 3, at least one Magnus rotor 4 and a connection component 5. The structures and operations of the main shaft 2, the at least one lift blade 3, the at least one Magnus rotor 4 and the connection component 5 are similar to those of FIG. 5A, and are not redundantly described herein. Compared with the shape of the lift blade 3 of FIG. 5A, the shape of the lift blade 3 of this embodiment is straight line wing blade. Moreover, the number of the Magnus rotor 4 of this embodiment is two. The two ends of each Magnus rotor 4 include an end plate 43, respectively. The end plate 43 is made by circular plate. The diameter of the end plate 43 is greater than the diameter of the corresponding Magnus rotor 4. Moreover, the periphery surface of the Magnus rotor 4 includes bulk convex or strip convex for increasing the Magnus effect. The connection component 5 of this embodiment is for example but not limited to a rod-shaped structure. The shape of the connection component 5 can be a streamline airfoil (such as the shape of NACA0012) for decreasing the drag force. Each second connection part 52 is connected with the main shaft 2 and the corresponding lift blade 3. Moreover, each second connection part 52 and the adjacent first connection part 51 are not limited to be located on the same level of the main shaft 2. The angle between each second connection part 52 and the adjacent first connection part 51 is for example but not limited to 90 degrees.

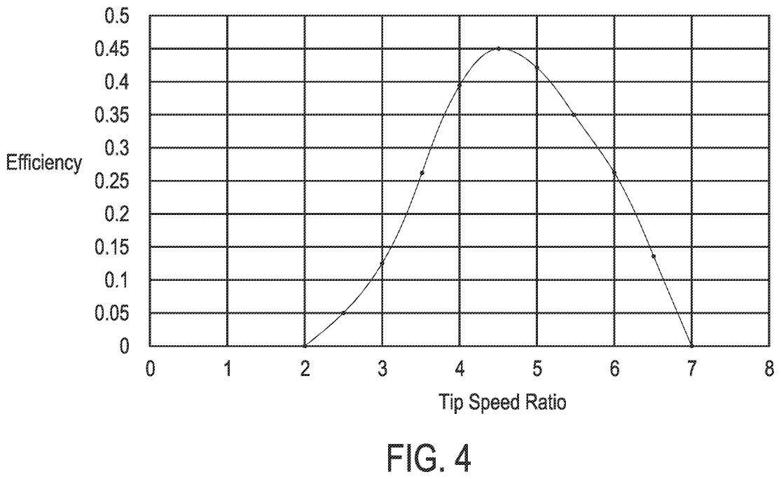

The embodiment of the lift blade 3 usually adopts the NACA0018 or NACA2412 airfoil which has a high lift-to-drag ratio (over 20 times). So the lift blade 3 can operate at the tip speed ratio more than four, as shown in FIG. 4. However, as is well known, the lift-to-drag ratio of the Magnus rotor 4 is usually about three, which is much lower than the lift-to-drag ratio of the lift blade 3. Consequently, the Magnus rotor 4 must be operated at a lower tip speed ratio than the lift blade 3, or the Magnus rotor 4 will endure high drag force and cause poor efficiency. Because the revolution angular velocity of the Magnus rotor 4 is the same with the revolution angular velocity of the lift blade 3, the tip speed ratio is proportional to the revolution radius according to formula (1) for both the lift blade 3 and the Magnus rotor 4. Consequently, the revolution radius of the Magnus rotor 4 revolved around the first axis 21 must be less than the revolution radius of the lift blade 3 revolved around the first axis 21. Usually the revolution radius of the Magnus rotor 4 revolved around the first axis 21 is less than ½ times the revolution radius of the lift blade 3 revolved around the first axis 21. Therefore, the distance between each Magnus rotor 4 and the adjacent lift blade 3 is greater than the distance between the Magnus rotor 4 and the main shaft 2, so each Magnus rotor 4 is far away from the adjacent lift blade 3, so that the flow field nearby the lift blade 3 is not influenced. Consequently, the performance of each lift blade 3 can be fully utilized and the performance of the vertical axis fluid energy conversion device la is enhanced. For reducing the drag force of the Magnus rotor 4, the height of each Magnus rotor 4 along the direction of the first axis 21 is less than the height of the lift blade 3. Hence, the cross-sectional area of the Magnus rotor 4 is reduced, and the performance is more enhanced.

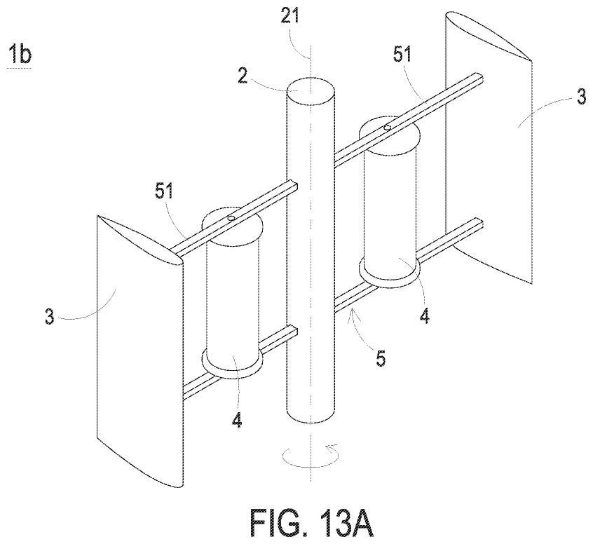

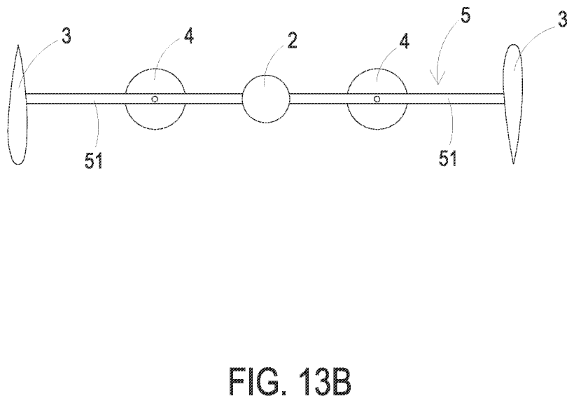

FIG. 13A is a schematic perspective view illustrating a vertical axis fluid energy conversion device according to a third embodiment of the present disclosure. FIG. 13B is a top view illustrating the vertical axis fluid energy conversion device of FIG. 13A. As shown in FIGS. 13A and 13B, the vertical axis fluid energy conversion device 1b of this embodiment includes a main shaft 2, at least one lift blade 3, at least one Magnus rotor 4 and a connection component 5. The structures and operations of the main shaft 2, the at least one lift blade 3, the at least one Magnus rotor 4 and the connection component 5 are similar to those of FIG. 5A, and are not redundantly described herein. Compared with the shape of the lift blade 3 of FIG. 5A, the shape of the lift blade 3 of this embodiment is straight line wing blade. Moreover, the connection component 5 only includes two first connection parts 51. Two ends of each first connection part 51 are connected with the lift blade 3 and the main shaft 2, respectively. Each Magnus rotor 4 is connected with the middle section of the corresponding first connection part 51, so that each Magnus rotor 4 is located between the corresponding lift blade 3 and the main shaft 2. The distance between each Magnus rotor 4 and the adjacent lift blade 3 is greater than the diameter of the cylinder of the Magnus rotor 4 for avoiding influencing the performance of the lift blade 3.

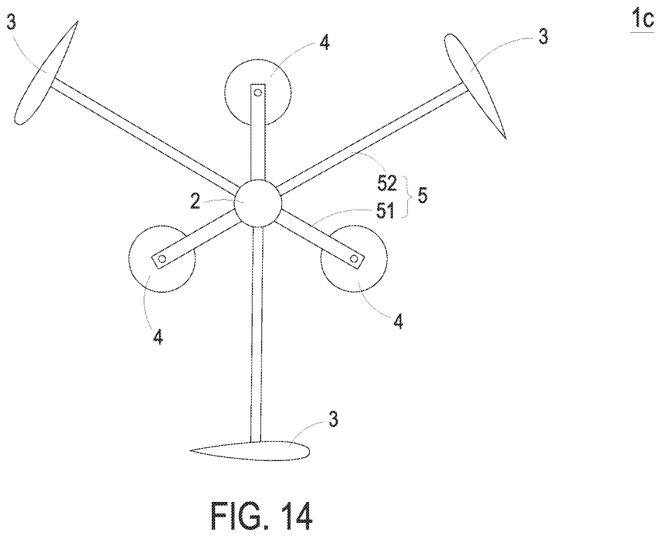

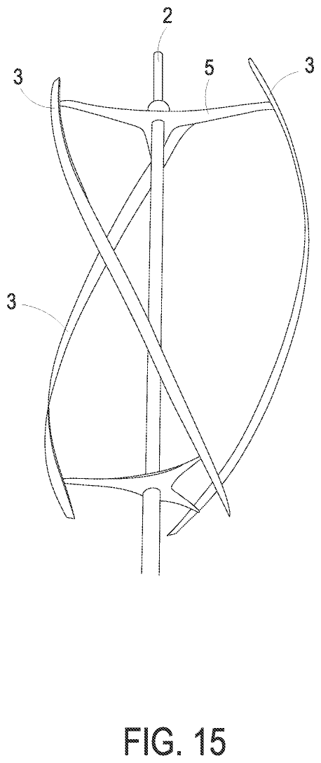

FIG. 14 is a top view illustrating a vertical axis fluid energy conversion device according to a fourth embodiment of the present disclosure. As shown in FIG. 14, the vertical axis fluid energy conversion device 1c of this embodiment includes a main shaft 2, at least one lift blade 3, at least one Magnus rotor 4 and a connection component 5. The structures and operations of the main shaft 2, the at least one lift blade 3, the at least one Magnus rotor 4 and the connection component 5 are similar to those of FIG. 5A, and are not redundantly described herein. Compared with the shape of the lift blade 3 of FIG. 5A, the shape of the lift blade 3 of this embodiment is straight line wing blade. In some embodiments, the shape of the lift blade 3 of this embodiment is spiral wing blade, as shown in FIG. 15. The number of the lift blade 3 is three and the number of the Magnus rotor 4 is three. The second connection part 52 of this embodiment is a rod-shaped structure. The second connection part 52 is connected between the main shaft 2 and the corresponding lift blade 3. The angle between each second connection part 52 and the adjacent first connection part 51 is for example but not limited to 60 degrees.

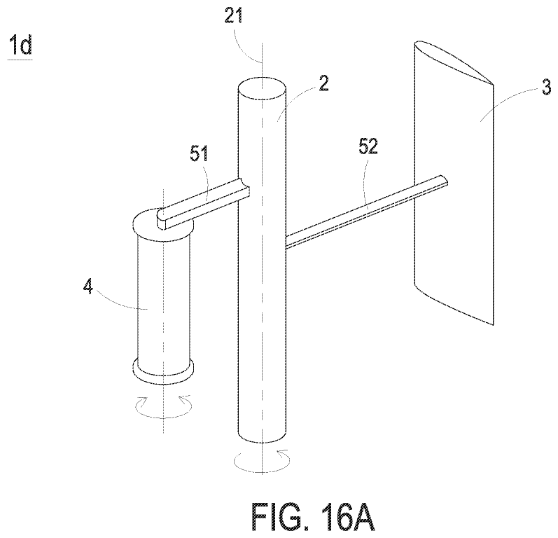

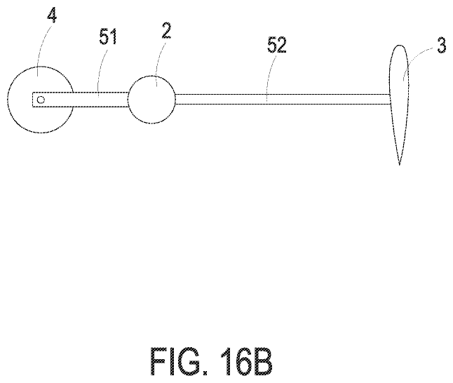

FIG. 16A is a schematic perspective view illustrating a vertical axis fluid energy conversion device according to a sixth embodiment of the present disclosure. FIG. 16B is a top view illustrating the vertical axis fluid energy conversion device of FIG. 16A. As shown in FIGS. 16A and 16B, the vertical axis fluid energy conversion device 1d of this embodiment includes a main shaft 2, at least one lift blade 3, at least one Magnus rotor 4 and a connection component 5. The structures and operations of the main shaft 2, the at least one lift blade 3, the at least one Magnus rotor 4 and the connection component 5 are similar to those of FIG. 5A, and are not redundantly described herein. Compared with the shape of the lift blade 3 of FIG. 5A, the shape of the lift blade 3 of this embodiment is straight line wing blade. The number of the lift blade 3 is one, and the number of the Magnus rotor 4 is one. Moreover, the number of the first connection part 51 of this embodiment is one, and the number of the second connection part 52 is one. The second connection part 52 of this embodiment is a rod-shaped structure. The second connection part 52 is connected between the main shaft 2 and the lift blade 3.

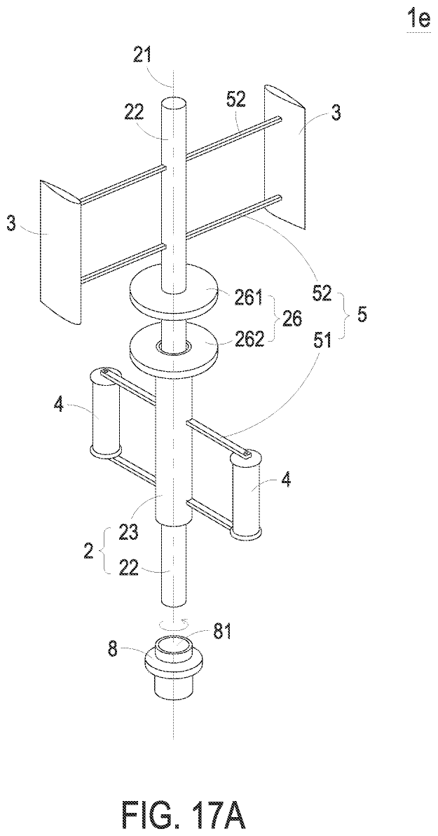

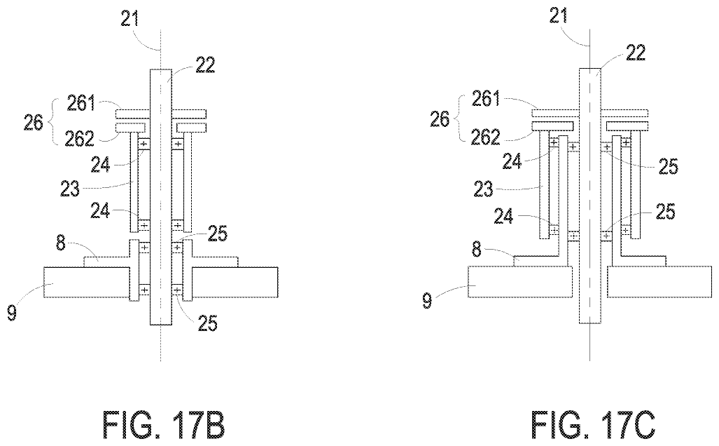

FIG. 17A is a schematic perspective view illustrating a vertical axis fluid energy conversion device according to a seventh embodiment of the present disclosure. FIG. 17B is a cross-sectional view illustrating portion of an exemplary vertical axis fluid energy conversion device of FIG. 17A. As shown in FIGS. 17A and 17B, the vertical axis fluid energy conversion device le of this embodiment includes a main shaft 2, at least one lift blade 3, at least one Magnus rotor 4 and a connection component 5. The structures and operations of the main shaft 2, the at least one lift blade 3, the at least one Magnus rotor 4 and the connection component 5 are similar to those of FIG. 5A, and are not redundantly described herein. Compared with the main shaft 2 of FIG. 5A, the main shaft 2 of this embodiment includes a main body 22, a sleeve 23 and a first bearing 24. The first axis 21 is constituted of an axis line which passes through the center of a top end of the main body 22 and the center of a bottom end of the main body 22. The main body 22 is rotated around the first axis 21. The sleeve 23 is a hollow tubular structure. The inner diameter of the sleeve 23 is greater than the outer diameter of the main body 22, so that the sleeve 23 can be sleeved on the outside of the main body 22. The first bearing 24 is disposed between the main body 22 and the sleeve 23. The sleeve 23 and the main body 22 are formed as a concentric structure by the first bearing 24, so that the sleeve 23 and the main body 22 can rotate around the first axis 21 independently. The rotation speed of the sleeve 23 can be different from the rotation speed of the main body 22.

Moreover, in this embodiment, the main shaft 2 further includes a clutch 26. The clutch 26 controls the sleeve 23 and the main body 22 to engage or disengage. The clutch 26 is a bidirectional clutch or a unidirectional clutch. The clutch 26 includes a first side 261 and a second side 262. The first side 261 of the clutch 26 is fixed on the main body 22. The second side 262 of the clutch 26 is fixed on the sleeve 23. The number of the Magnus rotor 4 is for example but not limited to two, and the number of the lift blade 3 is for example but not limited to two. Each Magnus rotor 4 is connected with the sleeve 23 through the corresponding first connection part 51. Each lift blade 3 is connected with the main body 22 through the corresponding second connection part 52. Moreover, the level of the first connection part 51 disposed on the first axis 21 is different from the level of the second connection part 52 disposed on the first axis 21. Consequently, the Magnus rotor 4 connected with the first connection part 51 and the lift blade 3 connected with the second connection part 52 can revolve around the first axis 21 independently and respectively without collision.

While the lift blade 3 is required to revolve, the Magnus rotor 4 is driven to rotate by the power source 41 and the Magnus lift force is produced, which is applied to the moment arm formed by the first connection part 51 to produce the torque, so that the sleeve 23 is rotated around the first axis 21 in response to the torque. Meanwhile, control the clutch 26 in an engaged state. The sleeve 23 will drive the main body 22 to rotate around the first axis 21, so that the lift blade 3 is also driven to revolve around the first axis 21 through the second connection part 52. While the revolution speed of the lift blade 3 is greater than a speed threshold value, the lift blade 3 can produce sufficient torque to make the main body 22 continue to rotate without relying on the torque provided by the Magnus rotor 4, so that the Magnus rotor 4 can be stopped from rotating for saving energy and the clutch 26 can be disengaged, so the sleeve 23 is not driven by any torque and stops rotating. Since the main body 22 is disengaged from the sleeve 23, the torque produced by the lift blade 3 is totally utilized to drive the main body 22 to rotate without being dragged by the resistance of the Magnus rotor 4. Consequently, the efficiency of the vertical axis fluid energy conversion device 1e is enhanced. In an embodiment, the length of the first connection part 51 used to connect the sleeve 23 and the Magnus rotor 4 can be designed to be longer to obtain greater torque for reducing the start time of the lift blade 3. After the vertical axis fluid energy conversion device le is started and the clutch 26 is disengaged. The rotation of the main body 22 is not influenced by the drag force of the Magnus rotor 4 and the first connection part 51. Moreover, while the flowing speed of the fluid W is too high, the rotation speed of the main body 22 is too fast and the main body 22 is dangerous, only by engaging the clutch 26, the main body 22 will be decelerated to stop by the drag force of the Magnus rotor 4 and the first connection part 51. Consequently, an additional safety mechanism is provided, and the wear of the brake can be reduced.

Moreover, in this embodiment, the vertical axis fluid energy conversion device 1e is disposed on a base 9. The base 9 is a fixed surface or a tower. The vertical axis fluid energy conversion device 1e includes a holder 8. The holder 8 is fixed on the base 9 and includes a circular through hole 81. The main body 22 of the main shaft 2 is penetrated through the circular through hole 81 and is contacted with the holder 8 through a plurality of second bearings 25. So the main body 22 is supported on the base 9 through the holder 8 and can be rotated around the first axis 21.

FIG. 17C is a cross-sectional view illustrating portion of another exemplary vertical axis fluid energy conversion device of FIG. 17A. In some embodiments, as shown in FIG. 17C, the holder 8 is a hollow tubular structure. The inner diameter of the holder 8 is greater than the outer diameter of the main body 22. The outer diameter of the holder 8 is less than the inner diameter of the sleeve 23. Consequently, the holder 8 is disposed between the main body 22 and the sleeve 23. The holder 8 is contacted with the sleeve 23 through the plurality of first bearings 24, and the holder 8 is contacted with the main body 22 of the main shaft 2 through the plurality of second bearings 25. Consequently, the main body 22 of the main shaft 2 and the sleeve 23 are both supported by the holder 8, and the main body 22 of the main shaft 2 and the sleeve 23 both can be rotated around the first axis 21 independently. Therefore, while the clutch 26 is disengaged, the main body 22 does not need to drive the sleeve to rotate, nor does it need to support the weight of the sleeve 23 and the weight of the Magnus rotor 4, since the sleeve 23 is supported by the holder 8 through the plurality of first bearings 24, therefore, the weight supported by the main body 22 of the main shaft 2 is lighter, resulting in less friction. So the efficiency of the vertical axis fluid energy conversion device 1e is enhanced.

From the above descriptions, the vertical axis fluid energy conversion device of this disclosure includes at least one lift blade and at least one Magnus rotor. The rotation of the Magnus rotor produces the Magnus lift force. The Magnus rotor is connected with the main shaft through the connection component. The vertical axis fluid energy conversion device starts up the lift blade to revolve by the Magnus lift force of the Magnus rotor. Moreover, the Magnus rotor of the present disclosure is driven to rotate by the power source, and the required lift force can be obtained by increasing the rotation speed of the Magnus rotor. Consequently, the diameter of the Magnus rotor can be designed to be shorter. Compared with the conventional Savonius drag blade, the cross-sectional area of the Magnus rotor of this disclosure is reduced. Consequently, the flow field inside the vertical axis fluid energy conversion device is less influenced. So the performance of the lift blade of the present disclosure is better, that the whole efficiency of the vertical axis fluid energy conversion device is enhanced.

Furthermore, the lift blade of the present disclosure does not need to have a variable pitch design. The lift force generated by the Magnus rotor can drive the vertical axis fluid energy conversion device to achieve self-starting. So there are fewer moving parts, that the structure is more stable. Compared with the traditional vertical axis fluid energy conversion device that directly use the power source to drive the main shaft to rotate, the power source of the vertical axis fluid energy conversion device of the present disclosure only drives the Magnus rotor to rotate instead of driving the main shaft which is bulky. Consequently, the required power is smaller. So the vertical axis fluid energy conversion device of the present disclosure has advantages of low cost and low energy consumption.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A vertical axis fluid energy conversion device for converting a kinetic energy of a fluid to a mechanical energy, the vertical axis fluid energy conversion device comprising:
at least one lift blade;
a main shaft comprising a first axis, wherein the main shaft is rotated around the first axis;
at least one Magnus rotor, wherein each of the at least one Magnus rotor comprises a power source and a second axis, the power source drives the corresponding Magnus rotor to rotate around the corresponding second axis selectively; and
a connection component connected with the main shaft and the corresponding Magnus rotor, wherein each of the at least one Magnus rotor produces a lift force according to Magnus effect when each of the at least one Magnus rotor is rotated on the second axis, the connection component is served as a moment arm, and the lift force acts on the moment arm to form a torque, the main shaft is driven to rotate around the first axis in response to the torque, wherein each of the at least one Magnus rotor is also revolved around the first axis, the connection component is also connected with the main shaft and the corresponding lift blade, while each of the at least one Magnus rotor drives the main shaft to rotate, each of the at least one lift blade is also driven to revolve around the first axis, wherein while a revolution speed of the lift blade is greater than a speed threshold value, the efficiency of the lift blade is increased, a torque produced by the lift blade is greater than a resistance of the fluid and a friction of the main shaft, such that the main shaft is driven to rotate around the first axis even though each of the at least one Magnus rotor is stopped to rotate, wherein a revolution radius of each of the at least one Magnus rotor revolved around the first axis is less than ½ times a revolution radius of the lift blade revolved around the first axis, and the distance between each of the at least one Magnus rotor and the adjacent lift blade is greater than the diameter of the at least one Magnus rotor.

2. The vertical axis fluid energy conversion device to claim 1, wherein the vertical axis fluid energy conversion device comprises:
a fluid detection unit configured to detect a flowing speed and a flowing direction of the fluid and output a first detection signal;
a main shaft detection unit configured to detect a rotation angle of the main shaft rotated around the first axis and output a second detection signal; and
a control unit configured to receive the first detection signal and the second detection signal, wherein an angle difference is calculated according to the flowing direction of the fluid and the rotation angle of the main shaft rotated around the first axis, an angle between each of the at least one Magnus rotor and the flowing direction of the fluid is calculated according to the angle difference, a driving signal of the corresponding power source is obtained, the driving signal is outputted to the corresponding power source through a corresponding driving circuit to drive the corresponding Magnus rotor to rotate.

3. The vertical axis fluid energy conversion device to claim 2, wherein the control unit calculates a tip speed ratio according to the first detection signal and the second detection signal, the tip speed ratio is equal to a linear velocity of the lift blade divided by the flowing speed of the fluid, and the control unit controls a rotation speed and a rotation direction of each of the at least one Magnus rotor according to the tip speed ratio.

4. The vertical axis fluid energy conversion device to claim 3, wherein the control unit controls the rotation speed and the rotation direction of each of the at least one Magnus rotor to produce a torque in a same revolution direction as the lift blade in order to increase the revolution speed of the lift blade while the tip speed ratio is less than a first threshold value, wherein the control unit controls each of the at least one Magnus rotor to stop rotating while the tip speed ratio is greater than or equal to the first threshold value, wherein the first threshold value is less than the tip speed ratio corresponding to that the efficiency of the lift blade is a maximum value.

5. The vertical axis fluid energy conversion device to claim 2, wherein the control unit controls the amplitude of a rotation speed of each of the at least one Magnus rotor to increase while an actual rotation speed of the main shaft rotated around the first axis is less than a target rotation speed, wherein the control unit controls the amplitude of the rotation speed of each of the at least one Magnus rotor to maintain while the actual rotation speed of the main shaft rotated around the first axis is equal to the target rotation speed, wherein the control unit controls the amplitude of the rotation speed of each of the at least one Magnus rotor to decrease while the actual rotation speed of the main shaft rotated around the first axis is greater than the target rotation speed, in order that the actual rotation speed of the main shaft is controlled to track the target rotation speed.

6. The vertical axis fluid energy conversion device to claim 1, wherein the connection component comprises:
at least one first connection part, wherein each of the at least one first connection part is connected with the main shaft and the corresponding Magnus rotor; and
at least one second connection part, wherein each of the at least one second connection part is connected with the main shaft and the corresponding lift blade.

7. The vertical axis fluid energy conversion device to claim 1, wherein the connection component comprises a plurality of first connection parts, two ends of each of the plurality of first connection parts are connected to the corresponding lift blade and the main shaft respectively, each of the at least one Magnus rotor is connected to a middle section of the corresponding first connection part, so that each of the at least one Magnus rotor is located between the corresponding lift blade and the main shaft.

8. The vertical axis fluid energy conversion device to claim 1, wherein the lift blade is a curved wing blade, a straight line wing blade or a spiral wing blade.

9. The vertical axis fluid energy conversion device to claim 1, wherein the main shaft comprises:
a main body, wherein each of the at least one lift blade is connected with the main body through the connection component;
a sleeve, wherein each of the at least one Magnus rotor is connected with the sleeve through the connection component, the sleeve is a hollow tubular structure, an inner diameter of the sleeve is greater than an outer diameter of the main body, the sleeve is sleeved on the outside of the main body, the sleeve is contacted with the main body through a plurality of first bearings, and the sleeve and the main body are rotated around the first axis independently; and
a clutch, configured to control the sleeve and the main body to engage or disengage, wherein the clutch controls the Magnus rotor to revolve with the lift blade around the first axis, or the clutch controls the Magnus rotor not to revolve with the lift blade.

10. The vertical axis fluid energy conversion device to claim 9, wherein vertical axis fluid energy conversion device comprises a holder, the holder is a hollow tubular structure, an inner diameter of the holder is greater than the outer diameter of the main body, an outer diameter of the holder is less than the inner diameter of the sleeve, the holder is disposed between the main body and the sleeve, the holder is contacted with the sleeve through the plurality of first bearings, the holder is contacted with the main body through a plurality of second bearings, the main body and the sleeve are both supported by the holder, and the main body and the sleeve both can be rotated around the first axis independently.
